(19) United States
(12) Patent Application Publication
(10) Pub. No.: US 2007/0111086 A1
(43) Pub. Date: May 17, 2007

(54) BATTERY COVER LATCHING ASSEMBLY FOR PORTABLE ELECTRONIC DEVICE

(75) Inventors: Yong Li, Shenzhen (CN); Chia-Hua Chen, Shindian (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FIH CO.,LTD., Shindian (TW)

(21) Appl. No.: 11/309,434

(22) Filed: Aug. 4, 2006

(30) Foreign Application Priority Data
Nov. 17, 2005 (CN) 200510101528.9

(51) Int. Cl. H01M 2/10

(52) U.S. Cl. 429/97; 429/100

(57) ABSTRACT

A portable electronic device (80) has a battery cover (100) and a housing (300) releasably mounted with a battery cover latching assembly (200). The battery cover has a receiving hole (114). The housing has a positioning member (316). The battery cover latching assembly includes a latching member (201) and a resilient member (202). The latching member has a locking portion (2019). The resilient member has a first end (2021) and a second end (2022). The first end is mounted in the latching member. The second end is mounted with the battery cover. The latching member is installed in the receiving hole. The locking portion is engaged with the positioning member thereby mounting the battery cover to the housing. When the latching member is forced to move relative to the battery cover, the resilient member is twisted thereby making the latching member to move in an opposing direction.

### CROSS-REFERENCE TO RELATED APPLICATION

This application is related to another patent application entitled “BATTERY COVER LATCHING ASSEMBLY FOR PORTABLE ELECTRONIC DEVICE”, filed Feb. 03, 2006 with application Ser. No. 11/347,497, and with the same assignee as the instant application. This disclosure of the above identified application is incorporated herein by reference.

### FIELD OF THE INVENTION

The present invention generally relates to battery cover latching assemblies and, more particularly, to a battery cover latching assembly for use in a portable electronic device.

### DESCRIPTION OF RELATED ART

Batteries are widely used in portable electronic devices, such as personal digital assistants (PDAs), mobile phones, and the like. Conventional batteries are attachably received in housings of the electronic device, and battery covers are designed to connect with the housings to package the batteries. The batteries have to be replaced by opening the battery covers when the batteries are, e.g., damaged, dead, and/or otherwise in need of recharging or replacement.

A clasping structure or latching structure is used to engage a conventional battery cover with a housing of a portable electronic device. For example, the Alcatel OT310 mobile phone has a latching assembly for a battery cover. The latching assembly includes two hooks at one end of the battery cover and a locking pin protruding from the other end of the battery cover. Two grooves are defined in one end portion of a backside of a housing of the mobile phone, and a locking hole is defined in the other end portion of the backside of the housing. In assembly, the hooks are firstly inserted into the grooves in the backside of the housing. Then, the battery cover is pressed downwards onto the housing until the locking pin on the battery cover is inserted into the locking hole in the backside of the housing. The battery cover is thus assembled to the housing of the mobile phone. The latching assembly is simple in structure, and the engagement between the battery cover and the housing of the mobile phone is firm too. However, during disassembly, great effort is needed to remove the battery cover, thereby requiring a relatively substantial force to be exerted thereon. Therefore, the battery cover can be susceptible to damage. As a result, it can be difficult for a user to replace a battery in the conventional housing of the mobile phone.

Therefore, a new battery cover latching assembly is desired in order to overcome the above-described shortcomings.

### SUMMARY OF THE INVENTION

In one embodiment thereof, a portable electronic device has a battery cover, a battery cover latching assembly, and a housing. The battery cover and the housing are connected via the battery cover latching assembly. The battery cover has a receiving hole. The housing has a positioning member. The battery cover latching assembly includes a latching member and a resilient member. The latching member is provided with a locking portion. The resilient member has a first end and a second end. The first end is mounted with the latching member. The second end is mounted with the battery cover. The latching member is movably installed in the receiving hole of the battery cover. The locking portion is engaged with the positioning member thereby mounting the battery cover to the housing. When the latching member is forced to move relative to the battery cover, the resilient member is twisted thereby creating a force to enable the latching member to move in a substantially opposing direction.

Other advantages and novel features of the embodiments will become more apparent from the following detailed description thereof, when taken in conjunction with the accompanying drawings.

### BRIEF DESCRIPTION OF THE DRAWINGS

Many aspects of the battery cover latching assembly can be better understood with reference to the following drawings. The components in the drawings are not necessarily drawn to scale, the emphasis instead being placed upon clearly illustrating the principles of the present battery cover latching assembly and its potential applications. Moreover, in the drawings, like reference numerals designate corresponding parts throughout the several views.

FIG. 1 is an exploded, isometric view of a portable electronic device with a battery cover and a housing connected via a battery cover latching assembly, in accordance with a preferred embodiment;

FIG. 2 is an enlarged, isometric view of the battery cover shown in FIG. 1, and viewed from another aspect;

FIG. 3 is an enlarged, exploded view of the battery cover latching assembly shown in FIG. 1;

FIG. 4 is an enlarged, assembled view of the battery cover latching assembly shown in FIG. 3, and viewed from another aspect;

FIG. 5 is an enlarged, assembled view of the battery cover latching assembly and the battery cover shown in FIG. 1;

FIG. 6 is an enlarged, assembled view of the portable electronic device shown in FIG. 1;

FIG. 7 is a cut-away view of the portable electronic device along line VII-VII shown in FIG. 6;

FIG. 8 is an enlarged, isometric view of a portion in round VIII shown in FIG. 7, according to a first position; and

FIG. 9 is an enlarged, isometric view of a portion in round VIII shown in FIG. 7, according to a second position.

### DETAILED DESCRIPTION OF THE EMBODIMENTS

The present battery cover latching assembly is suitable for portable electronic devices, such as mobile phones, PDAs, and the like.

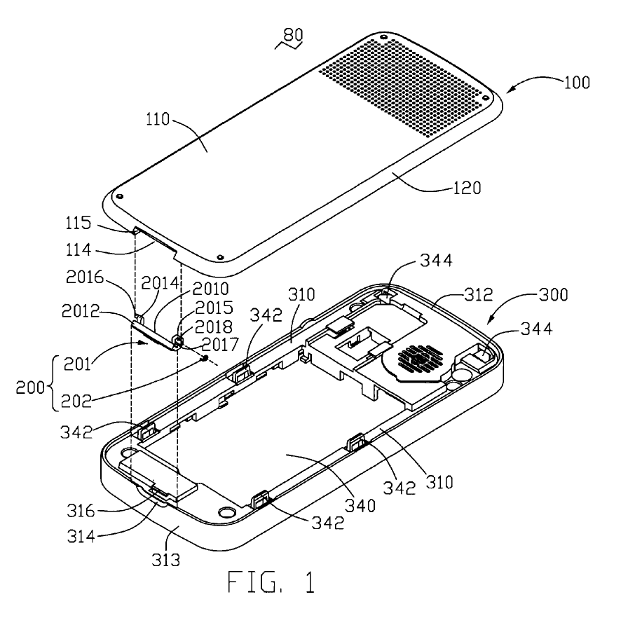

Referring now to the drawings in detail, FIG. 1 shows a battery cover latching assembly 200 for use in a mobile phone 80. The mobile phone 80 is taken here as an exemplary application, for the purposes of describing details of the battery cover latching assembly 200 of a preferred embodiment of the present assembly. The mobile phone 80 includes a housing 300 and a battery cover 100, connected via the battery cover latching assembly 200. The battery cover latching assembly 200 includes a latching member 201 and a resilient member 202. The battery cover 100 defines a receiving hole 114 therein. The battery cover latching assembly 200 is mounted in the receiving hole 114 of the battery cover 100 and releasably locks the battery cover 100, thereby interconnecting the housing 300 and the battery cover 100.

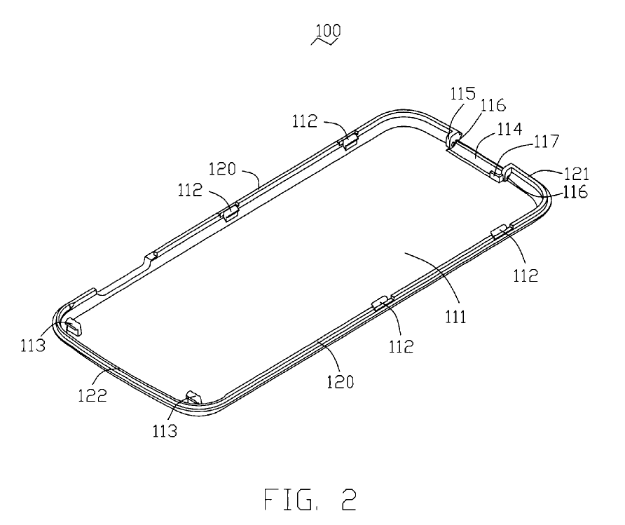

Also referring to FIG. 2, the battery cover 100 includes a rectangular body 110, a top end wall 121, a bottom end wall 122, and two sidewalls 120. The top end wall 121 is opposite to the bottom end wall 122. The top end wall 121, the bottom end wall 122, and the sidewalls 120 all extend from a periphery of the body and towards a same direction. The body 110 has an inner surface 111. Each sidewall 120 is provided with a pair of side hooks 112. The top end of each hook 112 is bent towards the opposite sidewall 120. The top end wall 121 defines the receiving hole 114 in a central portion. Two protrusions 115 extend from the top end wall 121, towards the inner surface 111, and adjacent to the receiving hole 114. Each protrusion 115 defines a mounting hole 116 therethrough. The two mounting holes 116 are coaxially arranged. A positioning flake 117 extends from a distal end of one protrusion 115 towards the other protrusion 115. The positioning flake 117 defines a positioning hole (not shown) therein. Two end hooks 113 extend from the inner surface 111 each respectively adjacent to one of the two sidewalls 120 and both adjacent to the bottom end wall 122. A top end of each end hook 113 is bent towards the bottom end wall 122.

Further referring to FIG. 1, the housing 300 has a substantially rectangular body, two opposing sidewalls 310, a top end portion 312, and a bottom end portion 313. The sidewalls 310, the top end portion 312, and the bottom end portion 313 all extend from a periphery of the body towards a same direction thereby forming a battery cavity 340 for receiving a battery (not shown). The bottom end portion 313 defines a cutout 314 in a central end portion. A positioning protrusion 316 extends from a top surface of the bottom end portion 313 and towards the cutout 314. Each sidewall 310 has two frames 342 mounted thereon. Each frame 342 is configured for engaging with one corresponding side hook 112 of the battery cover 100. Two end hook holes 344 are respectively defined in two corners of the top end portion 312. Each end hook 113 of the battery cover 100 is configured for being received in one corresponding end hook hole 344.

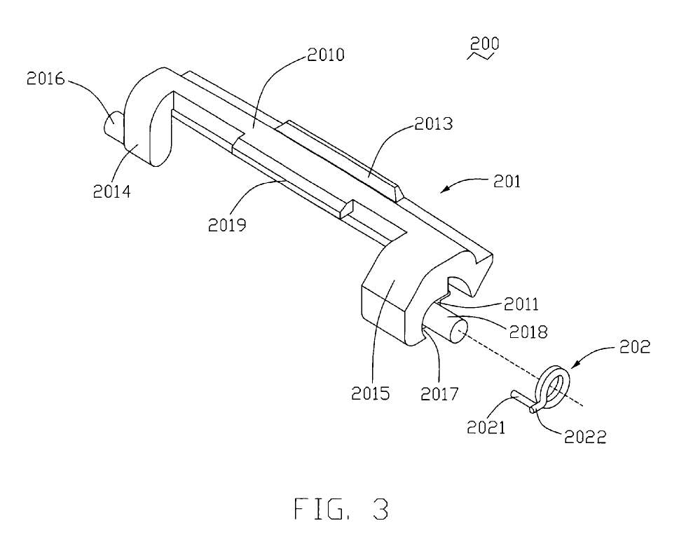

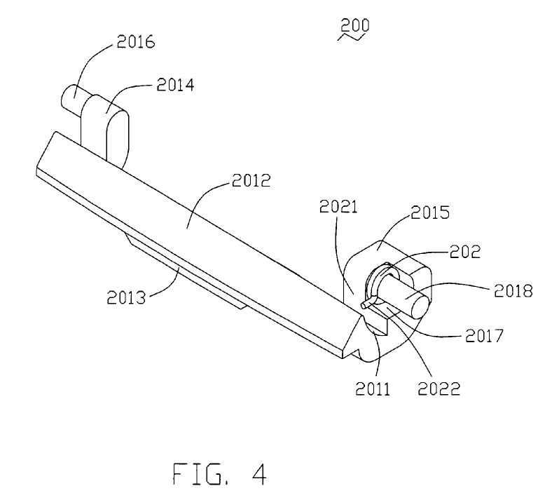

Also referring to FIGS. 3-5, the battery cover latching assembly 200 is configured to be received in the receiving hole 114 of the battery cover 100. The battery cover latching assembly 200 includes a latching member 201 and a resilient member 202.

The latching member 201 includes a body 2010, an operation portion 2013, a locking portion 2019, a first mounting foot 2014, and a second mounting foot 2015. The body 2010 is a deformed polygonal pole. The operation portion 2013 extends from one side of the body 2010. The locking portion 2019 extends from another side of the body 2010. The locking portion 2019 is configured for engaging with the positioning protrusion 316 of the housing 300. The mounting foot 2014 and the second mounting foot 2015 respectively extend from two opposite ends of the body 2010. A first mounting pole 2016 extends from a distal end of the first mounting foot 2014, in a same direction as the body extends, and away from the body 2010. The second mounting foot 2015 defines a hole 2017 in one side thereby forming an inner sidewall 2011. A second mounting pole 2018 extends from the inner sidewall 2011 and away from the body 2010. The first mounting pole 2016 and the second mounting pole 2018 are coaxially arranged. The first mounting pole 2016 and the second mounting pole 2018 are configured to be received in the mounting holes 115 of the battery cover 100. The inner sidewall 2011 defines a positioning hole (not shown) therein.

The resilient member 202 is substantially cylindrical in shape, and has a first end 2021 and a second end 2022. The first end 2021 extends in an axial direction and is configured for being received in the positioning hole of the latching member 201. The second end 2022 extends in a radial direction and is configured for being received in the positioning hole of the battery cover 100.

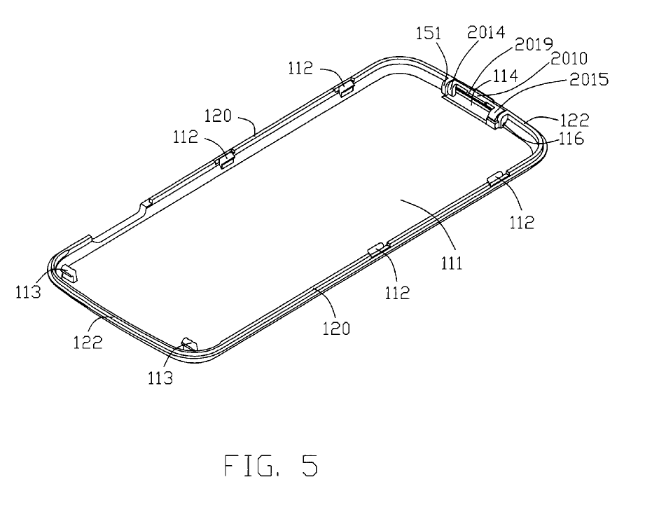

In assembly, the resilient member 202 surrounds the second mounting pole 2018 of the latching member 201 and the first end 2021 of the resilient member 202 is received in the positioning hole of the latching member 201. The mounting poles 2016, 2018 are respectively pushed into the mounting holes 115 of the battery cover 100. The mounting poles 2016, 2018 are rotatable in the mounting holes 115. The second end 2022 of the resilient member 202 is received in the positioning hole of the positioning flake 117 of the battery cover 100. The body 2010 and the mounting feet 2014, 2015 are received in the receiving hole 114 of the battery cover 100. The locking portion 2019 is located away from the inner surface 111 and towards the bottom end wall 122. The operation portion 2013 is exposed out of the receiving hole 114. Thus, the battery cover latching assembly 200 is assembled in the battery cover 100 and is rotatable about an axis of the mounting poles 2016, 2018, as shown in FIG. 5.

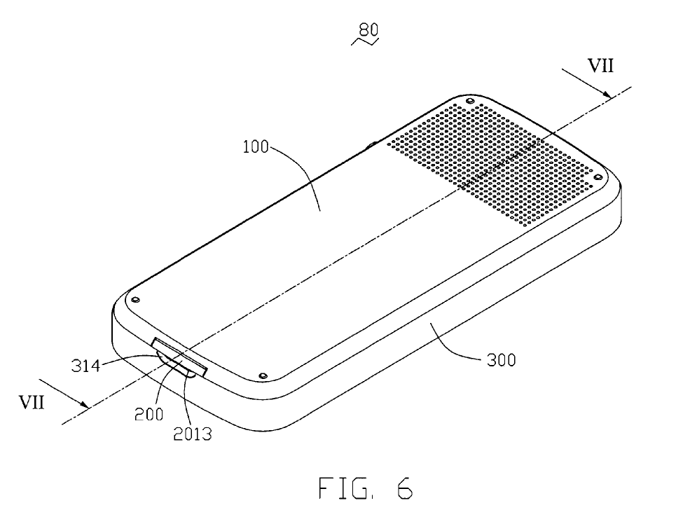

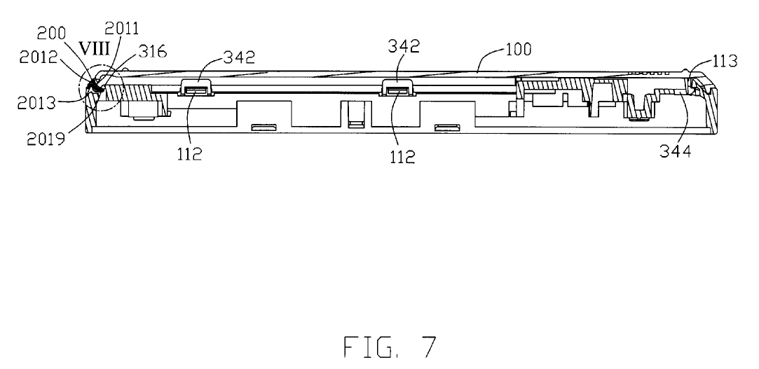

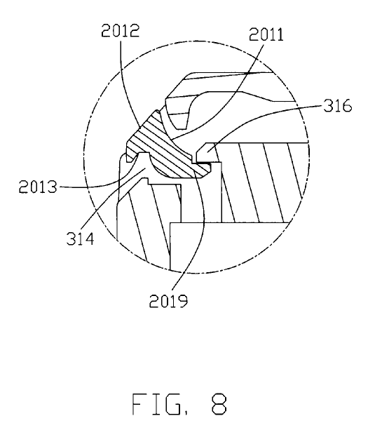

When the battery cover 100 is assembled to the housing 300, the end hooks 113 of the battery cover 100 are received in the end hook holes 344 of the housing 300. The side hooks 112 of the battery cover 100 are engaged with the frames 342 of the housing 300. The opposite end of the battery cover 100 is pressed down onto the housing 300. When the locking portion 2019 touches the positioning portion 316, the battery cover 100 is held down and the locking portion 2019 and then the latching member 201 are rotated about the axis of the mounting poles 2016, 2018. In this process the resilient member 202 is twisted. When the locking portion 2019 travels over the positioning portion 316, the latching member 201 moves in a substantially opposing direction due to the force of the resilient member 202. Now the locking portion 2019 and the positioning portion 316 are located in a first position and the locking portion 2019 resists the positioning portion 316. Thus, the battery cover 100 is assembled with the housing 300, as represented in FIGS. 6-8.

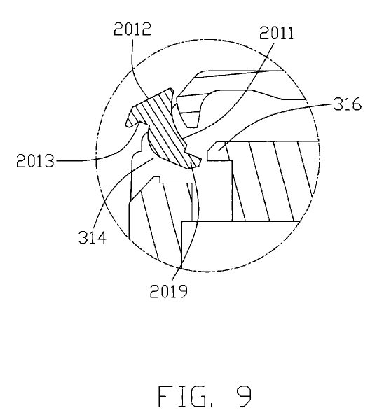

When the battery cover 100 is to be detached from the housing 300, the operation portion 2013 of the latching member 201 is manually moved towards the battery cover 100. The locking portion 2019 of the latching member 201 correspondingly moves out of engagement with the positioning portion 316. Now the locking portion 2019 and the positioning portion 316 are located in a second position, as represented in FIG. 9. In this process the resilient member 202 is twisted. The battery cover 100 is pulled away from the housing 300 manually. By releasing the operation portion 2013, the latching member 201 moves in an opposing direction due to the force of the resilient member 202.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A battery cover latching assembly for use in a portable electronic device, the portable electronic device having a battery cover and a housing connected via the battery cover latching assembly, the battery cover having a receiving hole, the housing having a positioning member, and the battery cover latching assembly comprising:
a latching member with a locking portion; and
a resilient member having a first end and a second end, the first end being mounted with the latching member, the second end being mounted with the battery cover;
wherein the latching member is movably installed in the receiving hole of the battery cover, the locking portion is engaged with the positioning member thereby mounting the battery cover to the housing, when the latching member is forced to move relative to the battery cover, the resilient member is twisted thereby creating a force enabling the latching member to move in a substantially opposing direction.

2. The battery cover latching assembly as claimed in claim 1, wherein the latching member further includes two mounting poles extending respectively from two opposite ends thereof, the battery cover has two mounting holes defined therein, and the mounting poles are rotatably received in the mounting holes.

3. The battery cover latching assembly as claimed in claim 2, wherein the resilient member surrounds one of the mounting poles.

4. The battery cover latching assembly as claimed in claim 2, wherein the latching member has a body, two mounting feet extend from two ends of the body towards a same direction, and the two mounting poles respectively extend from the mounting feet.

5. The battery cover latching assembly as claimed in claim 2, wherein the battery cover includes an end wall, the receiving hole is defined in the end wall, two protrusions extend from the end wall and respectively adjacent to the receiving hole, and the mounting holes are respectively defined in the protrusions.

6. The battery cover latching assembly as claim in claim 1, wherein the resilient member is substantially in a form of a cylinder and is located parallel to a pivot axis of the latching member.

7. The battery cover latching assembly as claim in claim 6, wherein the first end of the resilient member extends in an axial direction and the second end of the resilient member extends in a radial direction.

8. A portable electronic device comprising:
a battery cover having a receiving hole;
a housing having a positioning member, and
a battery cover latching assembly releasably connecting the battery cover and the housing, the battery cover latching assembly comprising:
a latching member with a locking portion; and
a resilient member being mounted between the latching member and the battery cover;
wherein the latching member is rotatably installed in the receiving hole of the battery cover, the locking portion is engaged with the positioning member thereby mounting the battery cover to the housing, when the latching member is forced to rotate relative to the battery cover, the resilient member is twisted thereby creating a force to enable the latching member to move in a substantially opposing direction.

9. The portable electronic device as claimed in claim 8, wherein the latching member further includes two mounting poles extending respectively from two opposite ends thereof, the battery cover has two mounting holes defined therein, and the mounting poles are rotatably received in the mounting holes.

10. The portable electronic device as claimed in claim 9, wherein the resilient member surrounds one of the mounting poles.

11. The portable electronic device as claimed in claim 9, wherein the latching member has a body, two mounting feet extend from two ends of the body towards a same direction, and the two mounting poles respectively extend from the two mounting feet.

12. The portable electronic device as claimed in claim 9, wherein the battery cover includes an end wall, the receiving hole is defined in the end wall, two protrusions extend from the end wall and respectively adjacent to the receiving hole, and the mounting holes are respectively defined in the protrusions.

13. The portable electronic device as claim in claim 8, wherein the resilient member is substantially cylindrical in shape and is located parallel to a pivot axis of the latching member.

14. The portable electronic device as claim in claim 13, wherein the resilient member has a first end and a second end, the first end extends in an axial direction, and the second end extends in a radial direction.

15. A portable electronic device comprising:
a housing including a battery cavity and a positioning portion formed adjacent to one side of the battery cavity;
a battery cover movable to a closed position for covering the battery cavity and movable to an opened position for opening the battery cavity;
a latching member rotatably attached to the battery cover, the latching member including a locking portion and an operation portion, wherein the locking portion engages with the positioning portion and the operation portion is exposed to an outside when the battery cover is in the closed position, the operation portion is configured so as to be operated to release the locking portion from the positioning portion; and a resilient member configured for biasing the locking portion into engagement with the positioning portion.

16. The portable electronic device of claim 15, wherein the resilient member is a coil spring having first and second mounting ends, and the first and second mounting ends are mounted with the latching member and the battery cover, respectively.

17. The portable electronic device of claim 15, wherein the housing includes a body and an end portion extending from a periphery of the body, and the end portion defines a hole for exposure of the operation portion.
